(19) United States
(12) Patent Application Publication
(10) Pub. No.: US 2012/0102528 A1
(43) Pub. Date: Apr. 26, 2012

(54) METHOD AND SYSTEM FOR FAVORITE TELEVISION SHOW DIRECTORY

(75) Inventor: DongWook Kim, San Diego, CA (US)

(73) Assignee: SONY CORPORATION, Tokyo (JP)

(21) Appl. No.: 12/911,630

(22) Filed: Oct. 25, 2010

(51) Int. Cl. H04N 5/445

(52) U.S. Cl. 725/46

(57) ABSTRACT

A system and method for displaying an electronic guide based on selected program genre. The method of displaying an electronic guide includes: identifying a favorite program. The genre of the favorite program is obtained and the favorite program is assigned to an appropriate list and the list is stored into a memory device. In response to the user selecting the list, the next time the favorite program can be viewed by the user and a channel on which the favorite program is available are displayed in a guide fashion. In response to the user selecting the favorite program displayed in the list, a viewing device is tuned to the channel on which the favorite program can be viewed. Favorite programs can be manually selected or automatically selected according to user behavior, e.g., viewing habits.

### FIELD

Embodiments according to the present invention generally relate to televisions, in particular to television viewing.

### BACKGROUND

Television owners typically pay a service provider for television shows. The service providers strive to provide as many different channels as possible. For example, local cable and satellite companies compete for business by offering hundreds of different channels to individual subscribers. Each channel broadcasts unique programming, so the individual user has thousands of programming choices in a day.

As competition increases between service providers, the number of channels and the number of programming choices increases. Thus, the user must spend more and more time searching for desired programs, either by flipping channels or reviewing programming guides which are organized according to channel number. Sometimes so much time is spent searching for a program, that by the time the user finally finds the program, the program has already started.

Some televisions and programming guides try to help the user by providing a favorite channel listing. Users are able to program a list of their favorite channels and create a much shorter channel list. In addition, some televisions and programming guides intelligently assign or suggest favorite channels to the user. However, these guides are still organized by channel number.

Moreover, by restricting the number of channels, favorite channel listings deprive users of one of the main things they are paying for, e.g., a large number of channels. Thus, users have a difficult choice. One user may spend a large amount of time looking through a large channel list for a program to watch, and miss a large portion of the program. Another user may spend a short amount of time looking through a small channel list for a program to watch, and entirely miss the program if it is on a channel that is not on the small list.

### SUMMARY

A system and method for displaying an electronic guide based on selected program genre. The method of displaying an electronic guide includes: identifying a favorite program. The genre of the favorite program is obtained and the favorite program is assigned to an appropriate list and the list is stored into a memory device. In response to the user selecting the list, the next time the favorite program can be viewed by the user and a channel on which the favorite program is available are displayed in a guide fashion. In response to the user selecting the favorite program displayed in the list, a viewing device is tuned to the channel on which the favorite program can be viewed. Favorite programs can be manually selected or automatically selected according to user behavior, e.g., viewing habits.

Embodiments of the invention provide a special user display, e.g., “guide,” on a television that includes favorite programs identified by the user and/or favorite programs automatically identified by the length of time the user has previously watched the programs. Favorite programs may be assigned to buttons on a remote control device, either automatically or manually by the user. The buttons may correspond to genres. Thus the user may select a button corresponding to a specific genre and the favorite programs related to that genre will be displayed. The user may then select one of the favorite programs for viewing.

Embodiments of the present invention are directed to a method and system of displaying an electronic guide. In one embodiment, a method of displaying information of specific interest to a user includes: identifying a favorite program and a genre of the favorite program; assigning the favorite program to a list based on the genre of the favorite program; maintaining the list in a memory device; in response to the user selecting a remote control selector corresponding to the list, displaying a next time the favorite program can be viewed and a channel on which the favorite program is available; and in response to the user selecting the favorite program displayed in the list, tuning a viewing device to the channel on which the favorite program can be viewed.

In one embodiment, the list includes a number of programs all belonging to the genre of the favorite program. In various embodiments, the displaying a number of favorite programs, and listing the number of favorite programs according to next times the number of favorite programs can be viewed.

In further embodiments, the identifying includes identifying the favorite program in response to a user selection identifying the favorite program. In some embodiments, the identifying includes automatically identifying the favorite program in response to a length of time the user has watched the favorite program exceeding a threshold amount.

In one embodiment, the method further includes identifying a user selected favorite program in response to a user selection identifying the user selected favorite program; automatically identifying a time selected favorite program in response to detecting a length of time the user has watched a program exceeding a threshold amount; and displaying a number of favorite programs that can be viewed at the same time, wherein the number of favorite programs includes the user selected favorite program and the time selected favorite program, wherein the user selected favorite program is listed before the time selected favorite program.

In further embodiments, the identifying includes identifying a user selected favorite program in response to the user selection identifying the user selected favorite program, automatically identifying a time selected favorite program in response to a detected length of time the user has watched a program exceeding a threshold amount, or identifying a suggested favorite program in response to one of the user selected favorite program and the time selected favorite program.

In another embodiment, a method of displaying information of specific interest to a user includes: determining a user preferred program based on detected user behavior; storing an identification of the user preferred program on a storage device according to a program genre of the user preferred program; in response to a user guide request, displaying the next time and channel the user preferred program can be viewed along with next times and channels of a number of programs of the program genre; and in response to a user guide selection from the displaying, rendering a program of a selected channel.

In some embodiments, the displaying includes displaying on one of a television screen and a remote control device. In various embodiments, the displaying the next time and channel the user preferred program can be viewed includes highlighting the user preferred program.

In one embodiment, the method further includes associating the program genre to a graphical representation of a favorite program genre on a television screen and to a remote control button. In further embodiments, then method further includes associating the program genre to a favorite program button of a remote control unit.

In some embodiments, the detected user behavior includes detected duration the user preferred program has been rendered. In various embodiments, the detected user behavior includes detecting a user selecting the user preferred program.

In another embodiment, a television includes: a processor; a display device coupled to the processor; an input device coupled to the processor; and memory coupled to the processor. The memory includes instructions that when executed cause the system to perform a method of displaying an electronic guide.

The method includes: identifying a favorite program and a genre of the favorite program; assigning the favorite program to a list based on the genre of the favorite program; in response to the user selecting a remote control selector corresponding to the list, displaying a next time the favorite program can be viewed and a channel on which the favorite program is available; and in response to the user selecting the favorite program displayed in the list, tuning a viewing device to the channel on which the favorite program can be viewed.

In some embodiments, the list includes a number of programs all belonging to the genre of the favorite program. In various embodiments, displaying includes displaying a number of favorite programs, and listing the number of favorite programs according to next times the number of favorite programs can be viewed.

In further embodiments, the identifying includes identifying the favorite program in response to a user selection identifying the favorite program, or automatically identifying the favorite program in response to a length of time the user has watched the favorite program exceeding a threshold amount.

In some embodiments, the identifying includes: identifying a user selected favorite program in response to a user selection identifying the user selected favorite program; automatically identifying a time selected favorite program in response to detecting a length of time the user has watched a program exceeding a threshold amount; and displaying a number of favorite programs that can be viewed at the same time, wherein the number of favorite programs includes the user selected favorite program and the time selected favorite program, wherein the user selected favorite program is listed before the time selected favorite program.

In various embodiments, the identifying includes: identifying a user selected favorite program in response to the user selection identifying the user selected favorite program; automatically identifying a time selected favorite program in response to a detected length of time the user has watched a program exceeding a threshold amount; and identifying a suggested favorite program in response to one of the user selected favorite program and the time selected favorite program.

These and other objects and advantages of the various embodiments of the present invention will be recognized by those of ordinary skill in the art after reading the following detailed description of the embodiments that are illustrated in the various drawing figures.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIGS. 1A and 1B are graphical depictions of an exemplary system capable of implementing a favorite television show directory, according to an embodiment of the present invention.

FIGS. 2A and 2B are graphical depictions of exemplary information screens for a favorite television show directory, according to an embodiment of the present invention.

FIGS. 3A and 3B are graphical depictions of an exemplary second favorite program display, according to an embodiment of the present invention.

FIGS. 4A and 4B are graphical depictions of an exemplary third favorite program display, according to an embodiment of the present invention.

FIG. 5 is a graphical depiction of the exemplary system illustrating an on-screen favorite keys setup user interface, according to an embodiment of the present invention.

FIG. 6 is a graphical depiction of an exemplary system illustrating an exemplary on-screen favorite program selection user interface, according to an embodiment of the present invention.

FIG. 7 is a block diagram of an example of a general purpose television system within which a system for rendering a favorite television show directory in accordance with the present invention can be implemented.

FIG. 8 depicts a flowchart of an exemplary television controlled method of displaying an electronic guide to a user, according to an embodiment of the present invention.

FIG. 9 depicts a flowchart of another exemplary television controlled method of displaying favorite television programs to a user, according to an embodiment of the present invention.

### DETAILED DESCRIPTION

Reference will now be made in detail to embodiments in accordance with the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

The drawings showing embodiments of the system are semi-diagrammatic and not to scale and, particularly, some of the dimensions are for the clarity of presentation and are shown exaggerated in the drawing Figures. Also, where multiple embodiments are disclosed and described having some features in common, for clarity and ease of illustration, description, and comprehension thereof, like features one to another will ordinarily be described with like reference numerals.

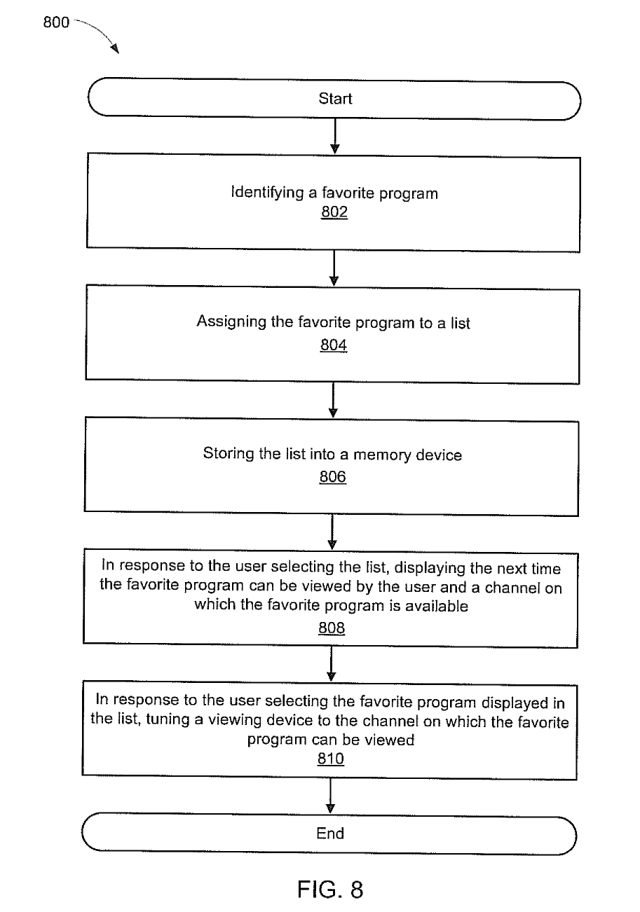

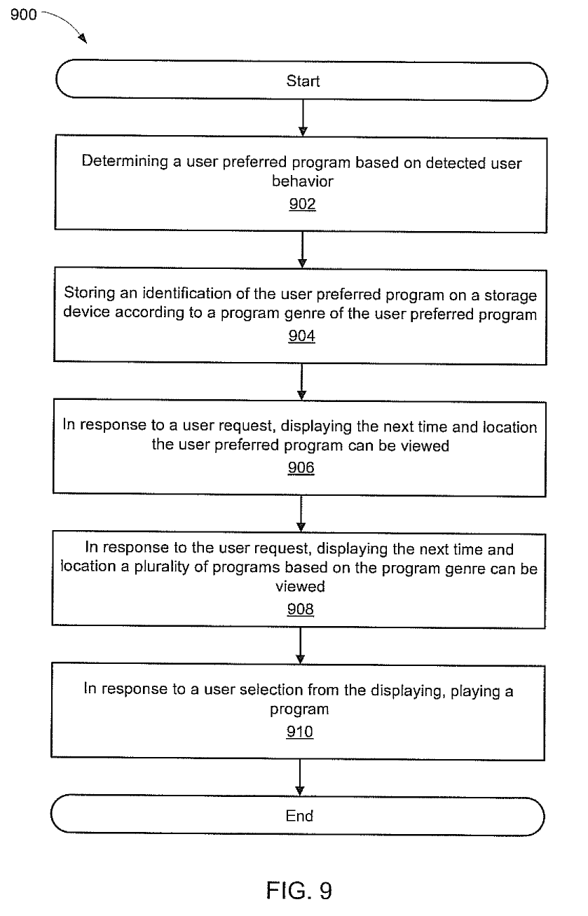

Some portions (e.g. FIG. 8 and FIG. 9) of the detailed descriptions, which follow, are presented in terms of procedures, steps, simulations, calculations, logic blocks, processing, and other symbolic representations of operations on data within a television system. These descriptions and representations are the means used by those skilled in the data processing arts to most effectively convey the substance of their work to others skilled in the art. A procedure, television-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a television system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions refer to the actions and processes of a television system, or similar electronic device, that manipulates and transforms data represented as physical (electronic) quantities within the television system's registers and memories into other data similarly represented as physical quantities within the television system memories or registers or other such information storage, transmission, or display devices.

### Method and System for Generating and Rendering a Favorite Television Show Directory or “Guide”

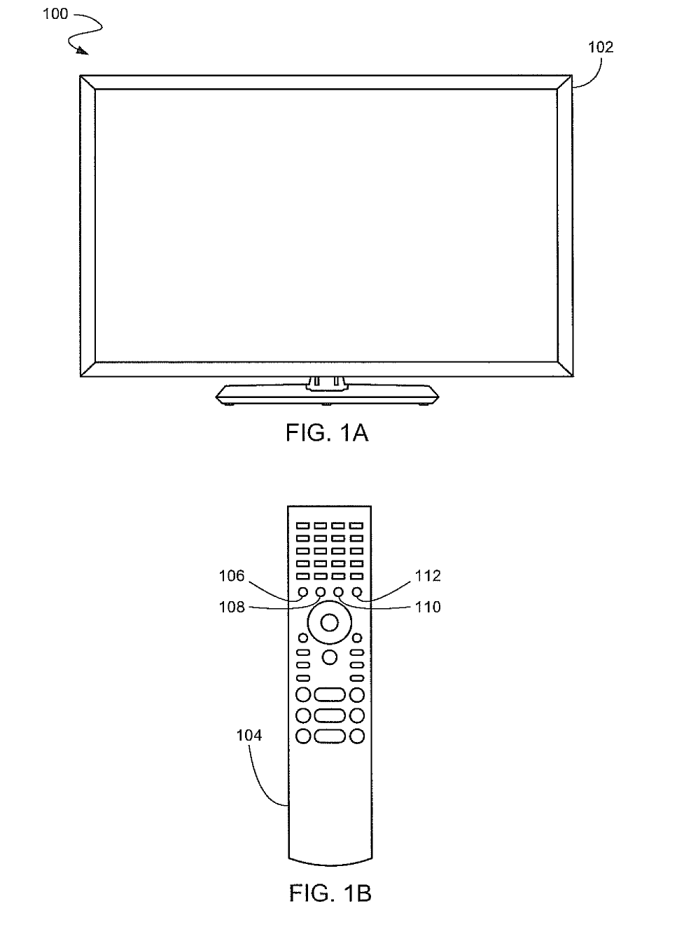

FIGS. 1A and 1B are graphical depictions of an exemplary system 100 for implementing a favorite television show directory, according to an embodiment of the present invention. The system 100 allows a user to have easy access to the user's favorite television programs. The system 100 presents searched and filtered television programs on the display screen based on a correlation to the user's preferences and/or viewing history.

A television system 102 displays content to a user (not shown). For example, the content may be a movie, a television program, internet streaming video, etc. The user may control the television system 102 with a remote control device 104. The remote control device 104 may be any device capable of controlling the television system 102. For example, the remote control device 104 may be an infrared remote control device, a radio frequency device, a LAN remote control device, or an application on a smart phone.

While viewing the television system 102, the user may be interested in watching a favorite program. The user may then press one of a number of favorite program buttons, e.g. favorite program button one 108, favorite program button two 110, favorite program button three 112, or favorite program button four 114. In alternate embodiments, any number of favorite program buttons may be used. By pressing a favorite button, a special display or guide is presented to the user on the television display.

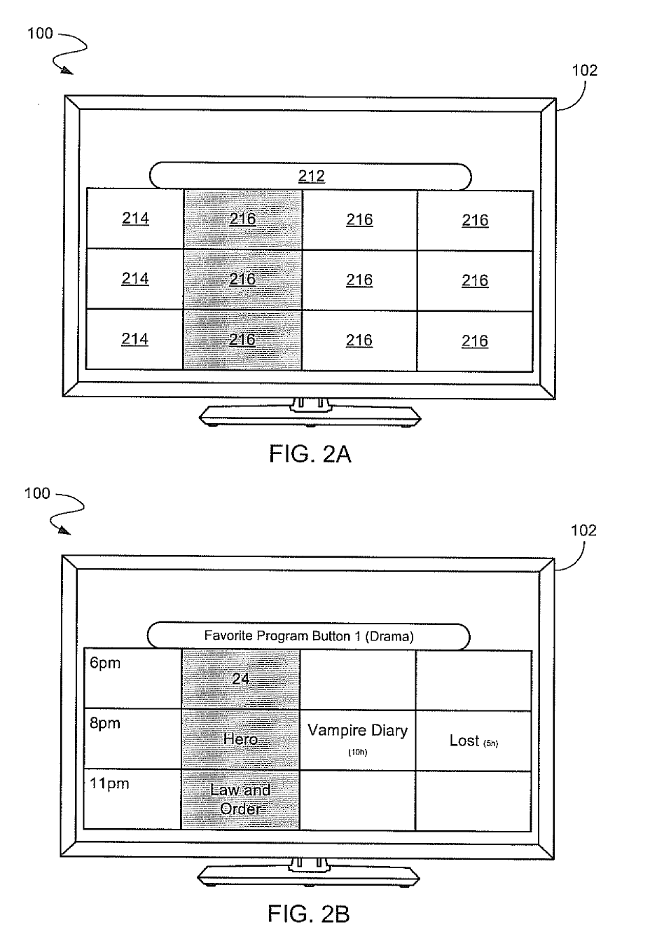

FIGS. 2A and 2B are graphical depictions of an exemplary favorite television show directory, according to an embodiment of the present invention. In response to the user selecting the favorite program button one 106 (See FIG. 1B), the system 100 displays a favorite program one information screen 212 on the television system 102. In an embodiment, the favorite program one information screen 212 may be displayed on the remote control device 104 (See FIG. 1B).

Thus for example, in FIG. 2B the user's favorite program button one is associated with a program genre, e.g., “Drama.” The Drama information screen displays a list of upcoming time slots and favorite Drama programs that will be available for viewing during those time slots. The user may navigate the guide using buttons on the remote control device, e.g., arrow buttons, select buttons, etc. The user may select one of the programs from the Drama information screen for viewing and the system will automatically display the program. The programs can be arranged based on those that will air closest in time to the present time.

Therefore in an embodiment, the favorite program one information screen 212 displays timeslots 214 and program listings 216. The program listings 216 are the user's favorite programs listed according to corresponding timeslots 214. The program listings 216 and the corresponding timeslots 214 may be ordered around the present time that the user selects a favorite program button. Thus for example, in FIG. 2B “24” is listed in the 6 pm timeslot, “Hero” is listed in the 8 pm timeslot, and “Law and Order” is listed in the 11 pm timeslot.

In an embodiment, the favorite program one information screen 212 visually highlights favorite programs that have been manually identified by the user as favorite programs. For example, “24,” “Hero,” and “Law and Order” are shaded. In some embodiments, any form of highlighting or visual designation may be used, e.g. various colors of shading, colored text, patterned backgrounds, etc. In further embodiments, favorite programs may be depicted by user ranked stars, e.g. one star means the user likes the program and four stars means the user really loves the program.

In an embodiment, the system 100 may automatically determine a favorite program by tracking the amount of time a user watches individual programs. The system 100 may automatically make programming recommendations based on the amount of time the user has watched a program. For example, “Vampire Diary” and “Lost” have been suggested within the favorite program one information screen 212. In an embodiment, the amount of time a user has watched a program is also displayed. Alternatively, if a user fails to watch a program after a threshold period, that program may automatically be removed from the favorite listing for the particular genre.

In some embodiments, a threshold time limit may be set for adding or removing favorites. The time limit may be factory set, user adjustable, and/or remotely adjustable, e.g. over the internet. Any program that has been viewed by the user exceeding the threshold time limit is automatically suggested as a favorite program. The user may agree with the automatic suggestions and leave them, or the user may disagree with the automatic suggestions and manually remove them.

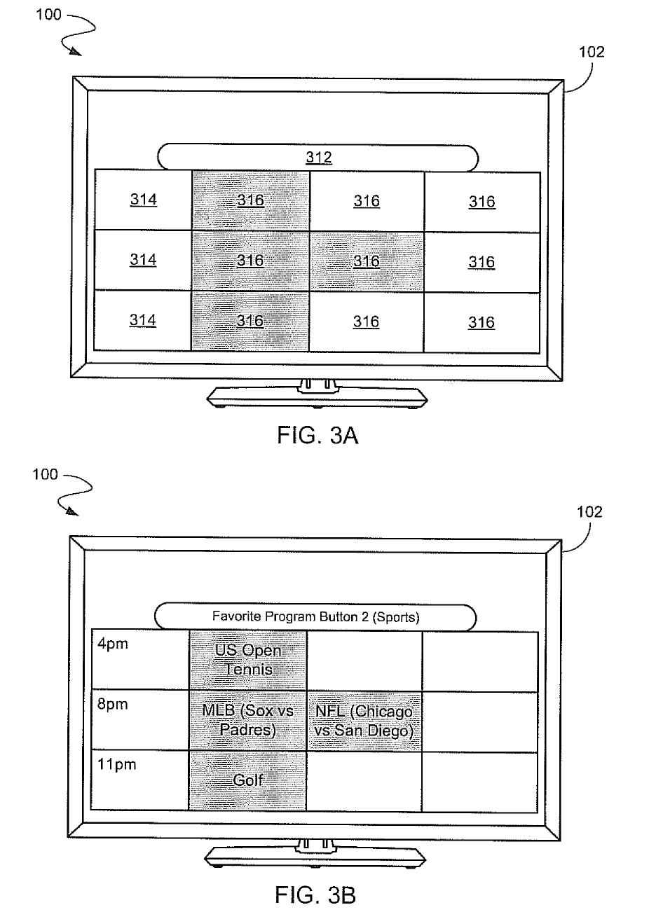

FIGS. 3A and 3B are graphical depictions of the exemplary system 100 illustrating a second favorite program display, according to an embodiment of the present invention. In response to the user selecting the favorite program button two 108 (See FIG. 1B), the system 100 displays a favorite program two information screen 312 on the television system 102. In an embodiment, the favorite program two information screen 312 may be displayed on the remote control device 104 (See FIG. 1B).

Thus for example, in FIG. 3B the user's favorite program button two is associated with another genre, e.g., “Sports.” The Sports information screen displays a list of upcoming time slots and favorite Sports programs that will be available for viewing during those time slots. The user may navigate the guide using buttons on the remote control device, e.g., arrow buttons, select buttons, etc. The user may select one of the programs from the Sports information screen for viewing. Again, the programs may be time ordered in accordance with the soonest air time, etc.

Therefore in an embodiment, the favorite program two information screen 312 displays timeslots 314 and program listings 316. The program listings 316 are the user's favorite programs listed according to corresponding timeslots 314. The program listings 316 and the corresponding timeslots 314 may be ordered around the present time that the user selects a favorite program button. Thus for example, in FIG. 3B “US Open Tennis” is listed in the 4 pm timeslot, “MLB (Sox vs Padres)” and “NFL (Chicago vs San Diego)” are listed in the 8 pm timeslot, and “Golf” is listed in the 11 pm timeslot. The timeslots 314 and program listings 316 may be stored, for example as a list, within a memory device in the system 100 or a memory device attached to the system 100. In an embodiment, the timeslots 314 and program listings 316 may be stored remotely via the internet, e.g. on a server.

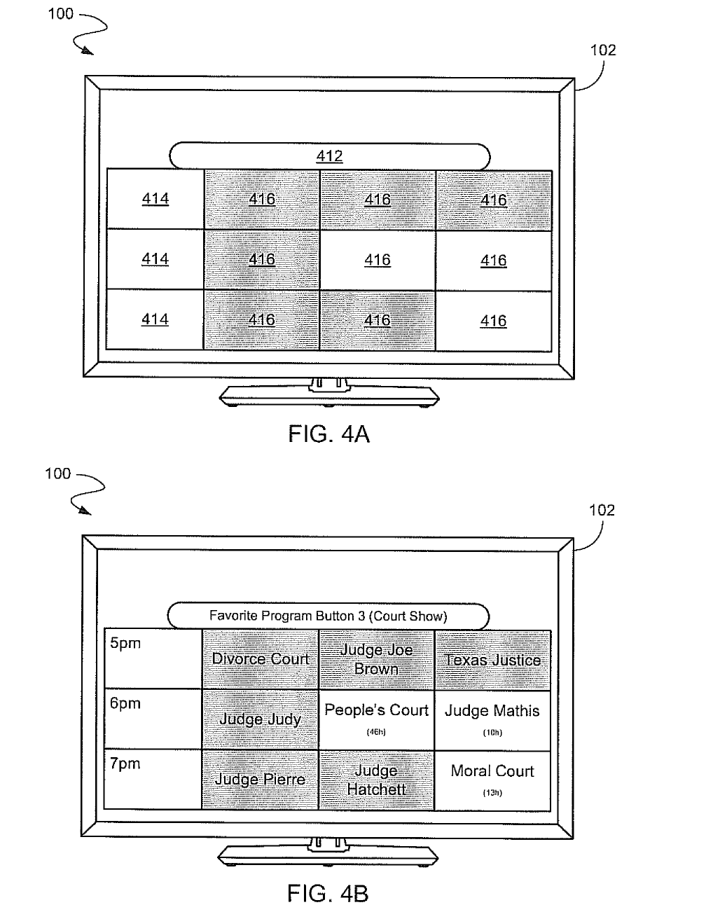

FIGS. 4A and 4B are graphical depictions of the exemplary system 100 illustrating a third favorite program display, according to an embodiment of the present invention. In response to the user selecting the favorite program button three 110 (See FIG. 1B), the system 100 displays a favorite program three information screen 412 on the television system 102. In an embodiment, the favorite program three information screen 412 may be displayed on the remote control device 104 (See FIG. 1B).

Thus for example, in FIG. 4B the user's favorite program button three is associated with yet another genre, e.g., “Court Show.” The Court Show information screen displays a list of upcoming time slots and favorite Court Show programs that will be available for viewing during those time slots. The user may navigate the guide using buttons on the remote control device, e.g., arrow buttons, select buttons, etc. The user may select one of the programs from the Court Show information screen for viewing. The listing can be ordered according to the most recent air time.

Therefore in an embodiment, the favorite program three information screen 412 displays timeslots 414 and program listings 416. The program listings 416 are the user's favorite programs listed according to corresponding timeslots 414. The program listings 416 and the corresponding timeslots 414 may be ordered around the present time that the user selects a favorite program button.

Thus for example, in FIG. 4B “Divorce Court,” “Judge Joe Brown,” and “Texas Justice” are listed in the 5 pm timeslot, and the user has identified them all as favorite programs. “Judge Judy,” “People's Court,” and “Judge Mathis” are listed in the 6 pm timeslot. The user has identified “Judge Judy” as a favorite program. However, “People's Court” and “Judge Mathis” have been automatically identified by the system 100 as favorite programs. “Judge Pierre,” “Judge Hatchett,” and “Moral Court” are listed in the 7 pm timeslot.

In an embodiment, user selected favorite programs are listed before programs automatically recommended by the system 100. For example, “Judge Judy” is listed before “People's Court.” In addition in some embodiments, programs automatically recommended by the system 100 are listed in order by the amount of time the user has viewed each program. For example, “People's Court” has been viewed for 46 hours and “Judge Mathis” has been viewed for 10 hours. Therefore, “People's Court” is listed before “Judge Mathis.”

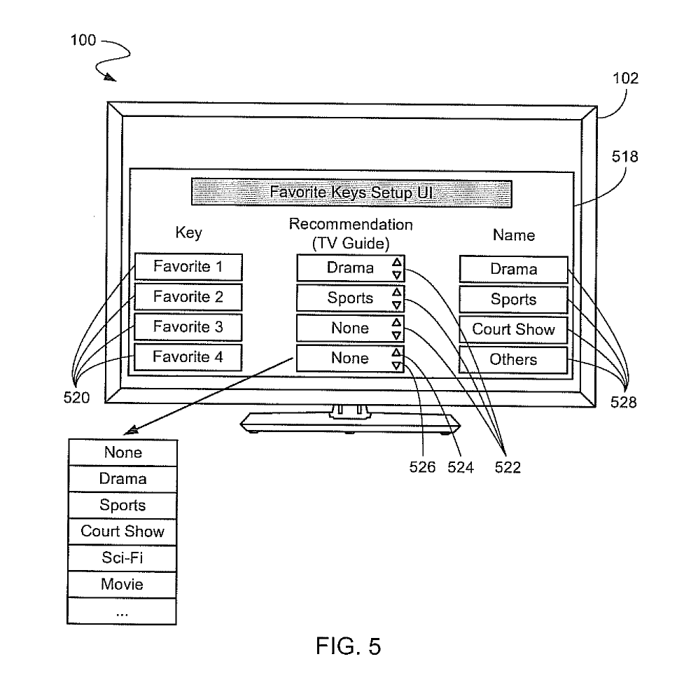

FIG. 5 is a graphical depiction of the exemplary system 100 illustrating an exemplary on-screen favorite keys setup user interface 518, according to an embodiment of the present invention. By using the favorite keys setup user interface 518, the user may select and then assign genres and names to the favorite keys.

In an embodiment, Favorite key listings 520 are listed in the favorite keys setup user interface 518. The favorite key listings 520 correspond to the favorite key buttons, for example on the remote control device 104 (FIG. 1B). Each of the favorite key listings 520 has a corresponding recommendation listing 522. The recommendation listing 522 may be a genre, name, category, or otherwise designation as used by or obtained from programming listings, e.g. a TV guide is program information meta data. The user may select and assign a genre to each of the favorite keys using, for example, an up arrow 524 or a down arrow 526. In an embodiment, other methods of scrolling and/or selecting may be used, e.g. a scroll bar or manual entry. The user may also assign a unique name to each of the favorite key buttons in a corresponding name field 528.

Thus for example, in FIG. 5 Favorite Key Four does not currently have an assigned genre. The user may use the arrows to scroll up or down a genre list, e.g. “Drama,” “Sports,” “Court Show,” “Sci-Fi,” “Movie,” etc. The user may also create a unique name for Favorite Key Four, for example “Sci-Fi.”

In an embodiment, when the user identifies a particular show as a favorite show either manually or by watching the show repeatedly, the system 100 will automatically determine the genre of the show based on the above meta data and assign it to the corresponding favorite button with the same or similar genre. In some embodiments, the user may not assign a genre to a favorite key, e.g. “None.” A favorite key with no assigned genre may list all of the user's favorite programs and/or list favorite programs that cannot be assigned to a favorite button.

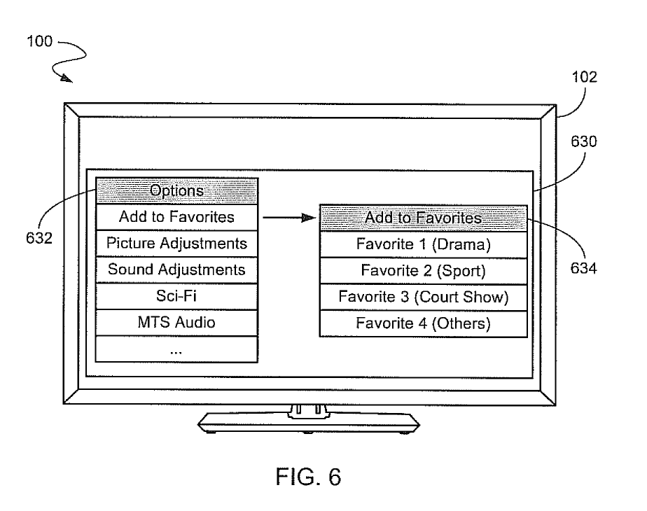

FIG. 6 is a graphical depiction of the exemplary system 100 illustrating an exemplary on-screen favorite program selection user interface 630, according to an embodiment of the present invention. By using the favorite program selection user interface 630, the user may manually assign favorite programs to the favorite keys. In an embodiment, the user selects an options menu 632, for example by using the remote control device 104 (See FIG. 1B). The user may then select an add to favorites menu 634 from the options menu 632. The user may then assign a favorite program to one or more of the favorite program buttons listed within the add to favorites menu 634. The favorite programs may be stored, for example as a list, within a memory device in the system 100 or a memory device attached to the system 100. In an embodiment, the favorite programs may be stored remotely via the internet, e.g. on a server.

In some embodiments, as discussed above, the system 100 automatically assigns a user selected favorite program to one of the favorite keys based on, for example, user selections and/or use behavior. For example, the user may identify a drama program as a favorite. The system 100 may then automatically assign the drama program to the favorite program button with the assigned genre “Drama.” In further embodiments, the user may not need to use menu screens to select a favorite program. For example, while viewing a program, the user may hold down one of the favorite program buttons for a prescribed time, for example five seconds. After one of the favorite program buttons has been held down for the designated time, the system 100 may then automatically assign the favorite program to the favorite program button that is being held down. On the other hand, the system 100 may automatically assign the favorite program to another favorite program button, for example a favorite program button with a corresponding assigned genre.

In an embodiment, the system 100 may automatically determine a favorite program by tracking the amount of time the television system 102 is displaying a particular program. The system 100 may automatically make programming recommendations based on the amount of time the television system 102 has been tuned to a particular program. Alternatively, if the television system 102 fails to display a program over a threshold period, that program may automatically be removed form the favorite listing.

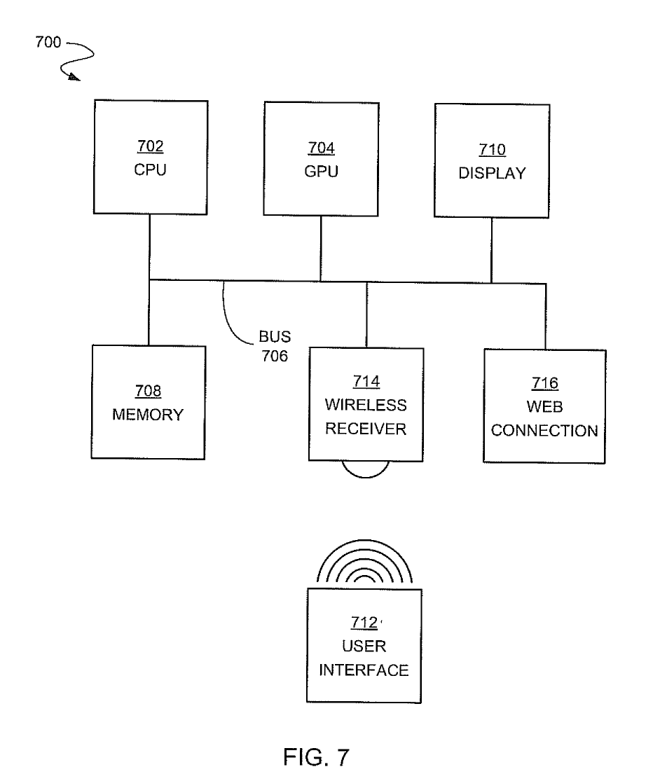

FIG. 7 is a block diagram of an example of a general purpose television system 700 within which a system for a favorite television show directory in accordance with the present invention can be implemented. In the example of FIG. 7, the system includes a host central processing unit (CPU) 702 coupled to a graphics processing unit (GPU) 704 and a web connection 716 via a bus 706. One or more CPUs as well as one or more GPUs may be used. The web connection 716 may be, for example, an Ethernet port, a cable modem, a DSL modem, etc.

Both the CPU 702 and the GPU 704 are coupled to memory 708. In the example of FIG. 7, the memory 708 may be a shared memory, whereby the memory stores instructions and data for both the CPU 702 and the GPU 704. Alternatively, there may be separate memories dedicated to the CPU 702 and GPU 704, respectively. In an embodiment, the memory 708 includes the system for a favorite television show directory in accordance with the present invention. The memory 708 can also include a video frame buffer for storing pixel data that drives a coupled display device 710. In further embodiments, the memory device may store user specific information, e.g. favorite program lists.

The system 700 also includes a user interface 712 that, in one implementation, includes an on-screen control device. The user interface may include an I/R or radio frequency remote control device, a LAN remote control device, or an application on a smart phone. The user interface 712 may be a wired interface (not shown) or a wireless interface communicating to a wireless receiver 714.

Generally speaking, the system 700 includes the basic components of a television system platform that implements functionality in accordance with embodiments of the present invention. The system 700 can be implemented as, for example, any of a number of different types of television systems (e.g., LED, Plasma, LCD, OLED, and CRT), as well as a home entertainment system (e.g., a DVD player) such as a set-top box or digital television, or a portable or handheld electronic device (e.g., a portable phone, personal digital assistant, handheld gaming device, or laptop computer).

FIG. 8 depicts a flowchart 800 of an exemplary television controlled method of displaying an electronic guide to a user, according to an embodiment of the present invention. Although specific computer steps are disclosed in the flowchart 800, such steps are exemplary. That is, embodiments of the present invention are well-suited to performing various other steps or variations of the steps recited in the flowchart 800.

In a step 802, a favorite program is identified. In some embodiments, the identifying includes identifying the favorite program in response to a user selection identifying a program as a user selected favorite program. In various embodiments, the identifying includes automatically identifying the favorite program in response to a length of time the user has watched a program exceeding a threshold amount. In yet another embodiment, a suggested favorite program is identified in response to the user selected favorite program or the time selected favorite program.

For example, in FIGS. 4A and 4B the system has displayed favorite television programs. The user has identified some of the programs, e.g. “Divorce Court” and “Judge Judy,” as favorite programs. The system has identified other programs, e.g. “People's Court” and “Judge Mathis,” as favorite programs based on the amount of time the user has watched those programs. If a threshold time limit of 5 hours was set, for example, then “People's Court” with 46 hours of viewing and “Judge Mathis” with 10 hours of viewing were automatically suggested by the system.

In a step 804 of FIG. 8, the favorite program is assigned to a list. In some embodiments, the assigning includes assigning the favorite program to the list based on a program type that is obtained via meta data from a program guide. In various embodiments, the program type includes the favorite program and other programs in the program type.

For example, in FIGS. 4A and 4B Court Shows have been assigned to the Favorite Program Button Three. The Favorite Program Button Three contains a number of assigned Court Shows. The Court Shows may be automatically assigned or manually assigned to Favorite Program Button Three (see FIG. 6).

In a step 806, the list is stored into a memory device. For example, in FIGS. 3A and 3B the timeslots and program listings may be stored in a memory device in the system or attached to the system. In some embodiments, the memory device may be remotely connected to the system, e.g. over the internet.

In a step 808, in response to the user selecting the button corresponding to the list, the next time the favorite program can be viewed by the user and a channel on which the favorite program is available is displayed. In some embodiments, the displaying includes displaying a number of favorite programs that can be viewed at the same or similar time window, wherein the number of programs includes the user selected favorite program and the time selected favorite program. The display may be ordered by air time of the programs. In various embodiments the user selected favorite program may be listed before the time selected favorite program. In an embodiment, the number of favorite program is listed according to the next time the number of favorite programs can be viewed.

For example, in FIGS. 4A and 4B the court shows have been listed in order of the times they can be viewed, e.g. “Divorce Court” is listed before “Judge Judy.” User selected favorite court shows are listed before court shows that have been automatically selected by the system as time selected favorite programs, e.g. “Judge Judy” is listed ahead of “People's Court.”

In a step 810, in response to the user selecting the favorite program displayed in the list, a viewing device is tuned to the channel on which the favorite program can be viewed. For example, in FIGS. 2A and 2B the user may select one of the programs listed on the Drama information screen. If the user selects, for example, “Hero” the system will automatically change the channel on the television to the channel broadcasting “Hero.”

FIG. 9 depicts a flowchart 900 of an exemplary television controlled method of displaying favorite television programs to a user, according to an embodiment of the present invention. Although specific computer steps are disclosed in the flowchart 900, such steps are exemplary. That is, embodiments of the present invention are well-suited to performing various other steps or variations of the steps recited in the flowchart 900.

In a step 902, a user preferred program is determined based on detected user behavior. In some embodiments, the detected user behavior includes detected user duration spent watching the user preferred program. In various embodiments, the detected user behavior includes detecting a user selecting the user preferred program.

For example, in FIGS. 4A and 4B the system has displayed favorite television programs. The user has identified some of the programs, e.g. “Divorce Court” and “Judge Judy,” as favorite programs. The system has identified other programs, e.g. “People's Court” with 46 hours of viewing and “Judge Mathis” with 10 hours of viewing, as favorite programs based on the amount of time the user has watched those programs.

In a step 904, an identification of the user preferred program is stored on a storage device according to a program genre of the user preferred program, e.g., obtain via program guide meta data of the program. In some embodiments, the program genre is associated to a graphical representation of a favorite program button on a television screen or a remote control. In various embodiments, the program genre is associated to a favorite program button of a remote control unit.

For example, in FIGS. 3A and 3B the timeslots and program listings may be stored in a memory device in the system or attached to the system. In some embodiments, the memory device may be remotely connected to the system, e.g. over the internet. Furthermore, in FIG. 5 genres may be assigned to favorite buttons displayed in the user interface. In some embodiments, the displayed favorite buttons correspond to favorite buttons on a remote control device.

In a step 906, in response to a user request to display guide information, the next time and location the user preferred program can be viewed is displayed. In some embodiments, the displaying the next time and location the user preferred program can be viewed includes highlighting the user preferred program. In various embodiments, the displaying includes displaying on a television screen or a remote control device.

For example, in FIGS. 2A and 2B the user has selected the Drama Favorite Program button. In response, the system has displayed a list of user favorite drama programs and the times they can be viewed. The drama programs that have been identified by the user as favorite programs are highlighted, e.g. “24,” “Hero,” and “Law and Order.” The information screen may be displayed on the television or on a remote control device.

In a step 908, in response to a user request, displaying the next time and location a number of programs based on the program genre can be viewed. In some embodiments, the displaying includes displaying on a television screen or a remote control device. For example, in FIGS. 4A and 4B “Divorce Court,” “Judge Joe Brown,” and “Texas Justice” are listed in the 5 pm timeslot, and the user has identified them all as favorite programs. “Judge Judy,” “People's Court,” and “Judge Mathis” are listed in the 6 pm timeslot. The user has identified “Judge Judy” as a favorite program. However, “People's Court” and “Judge Mathis” have been automatically identified by the system as favorite programs. “Judge Pierre,” “Judge Hatchett,” and “Moral Court” are listed in the 7 pm timeslot.

In a step 910, in response to a user selection from the displaying the number of programs, a program is played. For example, in FIGS. 2A and 2B the user may select one of the programs listed on the Drama information screen. If the user selects, for example, “Hero” the system will automatically change the channel on the television to the channel broadcasting “Hero.”

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A method of displaying an electronic guide, said method comprising:
identifying a favorite program and a genre of said favorite program;
assigning said favorite program to a list based on said genre of said favorite program;
maintaining said list in a memory device;
in response to said user selecting a remote control selector corresponding to said list, displaying a next time said favorite program can be viewed and a channel on which said favorite program is available; and
in response to said user selecting said favorite program displayed in said list, tuning a viewing device to said channel on which said favorite program can be viewed.

2. The method of claim 1 wherein said list comprises a plurality of programs all belonging to said genre of said favorite program.

3. The method of claim 1 wherein said displaying comprises:
displaying a plurality of favorite programs; and
listing said plurality of favorite programs according to next times said plurality of favorite programs can be viewed.

4. The method of claim 1 wherein said identifying comprises identifying said favorite program in response to a user selection identifying said favorite program.

5. The method of claim 1 wherein said identifying comprises automatically identifying said favorite program in response to a length of time said user has watched said favorite program exceeding a threshold amount.

6. The method of claim 1 further comprising,
identifying a user selected favorite program in response to a user selection identifying said user selected favorite program;
automatically identifying a time selected favorite program in response to detecting a length of time said user has watched a program exceeding a threshold amount; and
displaying a plurality of favorite programs that can be viewed at the same time, wherein said plurality of favorite programs comprises said user selected favorite program and said time selected favorite program, wherein
said user selected favorite program is listed before said time selected favorite program.

7. The method of claim 1 wherein said identifying comprises one of:
identifying a user selected favorite program in response to said user selection identifying said user selected favorite program;
automatically identifying a time selected favorite program in response to a detected length of time said user has watched a program exceeding a threshold amount; and
identifying a suggested favorite program in response to one of said user selected favorite program and said time selected favorite program.

8. A method comprising:
determining a user preferred program based on detected user behavior;
storing an identification of said user preferred program on a storage device according to a program genre of said user preferred program;
in response to a user guide request, displaying the next time and channel said user preferred program can be viewed along with next times and channels of a plurality of programs of said program genre; and
in response to a user guide selection from said displaying, rendering a program of a selected channel.

9. The method of claim 8 wherein said displaying comprises displaying on one of a television screen and a remote control device.

10. The method of claim 8 wherein said displaying the next time and channel said user preferred program can be viewed comprises highlighting said user preferred program.

11. The method of claim 8 further comprising associating said program genre to a graphical representation of a favorite program genre on a television screen and to a remote control button.

12. The method of claim 8 further comprising associating said program genre to a favorite program button of a remote control unit.

13. The method of claim 8 wherein said detected user behavior comprises detected duration said user preferred program has been rendered.

14. The method of claim 8 wherein said detected user behavior comprises detecting a user selecting said user preferred program.

15. A system comprising:
a processor;
a display coupled to said processor;
an input device coupled to said processor;
an audio output device coupled to said processor;
memory coupled to said processor, wherein said memory comprises instructions that when executed cause said system to perform a method of displaying an electronic guide, said method comprising:
identifying a favorite program and a genre of said favorite program;
assigning said favorite program to a list based on said genre of said favorite program;
maintaining said list in a memory device;
in response to said user selecting a remote control selector corresponding to said list, displaying a next time said favorite program can be viewed and a channel on which said favorite program is available; and
in response to said user selecting said favorite program displayed in said list, tuning a viewing device to said channel on which said favorite program can be viewed.

16. The system of claim 15 wherein said list comprises a plurality of programs all belonging to said genre of said favorite program.

17. The system of claim 15 wherein said displaying comprises:
displaying a plurality of favorite programs; and
listing said plurality of favorite programs according to next times said plurality of favorite programs can be viewed.

18. The system of claim 15 wherein said identifying comprises:
identifying said favorite program in response to a user selection identifying said favorite program; or
automatically identifying said favorite program in response to a length of time said user has watched said favorite program exceeding a threshold amount.

19. The system of claim 15 wherein,
said identifying comprises:
identifying a user selected favorite program in response to a user selection identifying said user selected favorite program;
automatically identifying a time selected favorite program in response to detecting a length of time said user has watched a program exceeding a threshold amount; and
displaying a plurality of favorite programs that can be viewed at the same time, wherein said plurality of favorite programs comprises said user selected favorite program and said time selected favorite program, wherein
said user selected favorite program is listed before said time selected favorite program.

20. The system of claim 15 wherein said identifying comprises one of:
identifying a user selected favorite program in response to said user selection identifying said user selected favorite program;
automatically identifying a time selected favorite program in response to a detected length of time said user has watched a program exceeding a threshold amount; and
identifying a suggested favorite program in response to one of said user selected favorite program and said time selected favorite program.
